(19) United States
(12) Patent Application Publication
(10) Pub. No.: US 2011/0095491 A1
(43) Pub. Date: Apr. 28, 2011

(54) Single-Layer Seal or Sealing Layer of a Multiple-Layer Seal and Method for its Production

(76) Inventor: Friedhelm Stecher, Wilhelmshaven (DE)

(21) Appl. No.: 12/947,343

(22) Filed: Nov. 16, 2010

Related U.S. Application Data
(63) Continuation of application No. PCT/EP2008/056077, filed on May 16, 2008.

(51) Int. Cl. F02F 11/00; B21D 53/84; B21D 22/00; B05D 3/12

(52) U.S. Cl. 277/593; 72/379.2; 72/46

(57) ABSTRACT

A single-layer seal or a sealing layer of a multi-layer seal made of metal includes supporting regions and sealing regions. At least one supporting region and at least one sealing region are embodied by a stamped sliding surface with a thickness that is greater than an original sheet-metal thickness. A step is stamped onto the upper side and/or the underside of the at least one sliding surface such that the sliding surface bends elastically in an installed state.

This application is a continuation of co-pending International Application No. PCT/EP2008/056077, filed May 16, 2008, which designated the United States and was not published in English and which application is incorporated herein by reference.

### TECHNICAL FIELD

The invention relates to a single-layer seal or a sealing layer of a multi-layer seal made of metal, which has supporting regions and sealing regions. Furthermore, the invention also relates to a method for producing such a seal or sealing layer.

### BACKGROUND

In particular in the case of cylinder head gaskets, a multi-layer steel seal is very widespread in practice. The steel seal is generally composed of a combination of thin beaded pieces of spring sheet steel as cover layers and a carrier piece of sheet metal which is arranged therebetween and which serves to support the beads in the cover layers.

The usable elasticity of a bead in conjunction with a support, such as is used in multi-layer seals, is relatively small.

If, for example, the supporting face is relieved of loading in a multi-layer seal, this leads to a situation in which the pieces of spring sheet metal are lifted off from the carrier layer by the elasticity of the bead.

A further disadvantage of the classic beads in single-layer seals is that owing to the offset arrangement of the sealing lines on the upper side and the underside it is possible for angular movements to occur when the engine is running.

European patent document EP 0 771 608 A1 and German patent document DE 195 20 695 C1 (U.S. Pat. No. 5,695,200) each disclose a three-layer seal with a stamped stopper in the central layer and a bead in the cover layer.

European patent document EP 1 600 671 A1 (U.S. Pat. No. 7,311,310) and German patent document DE 698 31 391 T2 (U.S. Pat. No. 6,186,513) disclose a seal with a stamped stopper and a bead. The stopper has in each case recesses lying opposite one another in an embodiment.

German patent document DE 44 21 219 A1 discloses a cylinder head gasket with recesses lying opposite one another.

### SUMMARY

In various embodiments, the invention discloses a seal or a sealing layer made of metal which is easy and cost-effective to produce.

According to one embodiment of the invention, at least one supporting region and one sealing region are embodied by a stamped sliding surface with a thickness which is increased compared to the original sheet-metal thickness, and for this purpose a step is stamped onto the upper side and/or the underside of the at least one sliding surface, by means of which step the sliding surface bends elastically in the installed state, and the sealing region is prestressed elastically.

The embodiment of the supporting and sealing region as a stamped sliding surface has the advantage that the supporting and sealing processes take place in a seal or sealing layer. Since the sliding surface is stamped and is embodied with a thickness which is increased compared to the original sheet-metal thickness, the latter can be produced cost-effectively and, moreover, is very stable since the sliding surface region is work-hardened by the stamping.

The step has the great advantage that a defined sealing line is produced and, depending on the arrangement of the step and also the height of the step, the elasticity of the sliding surface can be set.

The stamped step shape results, in the installed state, in elastic bending of the sliding surfaces with a supporting region and elastically prestressed sealing lines. The formation of the sealing edge is advantageously selected as a function of a coating which is applied later to the sliding surface.

The at least one step results in elastic-plastic deformation of the sliding surface during installation. An elastic-plastic stopper is therefore produced. The supporting regions are not deformed plastically and assume the classic stopper function. For example in the case of steps which are arranged offset opposite one another, the region between the steps is also deformed plastically to a certain degree. The sealing regions are prestressed with the remaining elasticity. The possibility of plastic deformation in the stopper allows a topographic design of the stopper to be dispensed with. A topographic design of the stopper is to be understood as the vertical profiling of the sliding surface in the respectively supporting region for adaptation to the sealing gap between the engine block and the cylinder head.

The step is advantageously not stamped in at a right angle but rather at an obtuse angle, and the angle is selected depending on the hardness and resistance to wear of the selected coating.

According to one preferred embodiment, the at least one sliding surface is produced by a combination of transverse stamping and perpendicular expulsion stamping in which a piece of sheet metal with a constant material thickness is transversely compressed in such a way that a relatively large material thickness is produced in the region of the sliding surface.

The production of a sliding surface by transverse stamping and perpendicular expulsion stamping has the advantage that no additional support is necessary during the stamping process and as a result the production can be carried out with a low stamping force. The support is provided by the stamped sliding surface per se so that no excess stamping force is required for the support. Further advantages for production by means of transverse stamping and perpendicular expulsion stamping are specified and explained below on the basis of the method disclosed herein.

The formation of the supporting and sealing region by a stamped sliding surface has the further advantage that the entire seal or sealing layer can be produced in a single stamping step. This is extremely cost-effective, in particular, compared to a multi-layer steel seal composed of cover layers and a piece of carrier sheet steel. Even when the sealing layer according to the invention is combined with a spring sheet steel layer this would lead to a considerable cost saving compared to a three-layer multi-layer seal.

It is advantageous here if the junction between the at least one sliding surface and the original surface of the seal is formed by at least one relatively thin hinge point.

The relatively thin hinge point permits the sliding surface to become oriented during the installation of the seal or the sealing layer. As a result of the step, the sliding surface assumes an oblique position during installation, and the relatively thin hinge point which connects the sliding surface to the rest of the original surface of the seal absorbs the deformation.

According to one embodiment in which a step is stamped on the upper side and underside of a sliding surface, it is possible to arrange these steps in such a way that the sealing edges run in parallel. This is advantageous in regions or in entire seals which have the same pressing force distribution over the length of the sealing edges and therefore have constant elasticity of the sliding surface at all locations over the length of the sealing edge.

Given the formation of a step on the upper side and on the underside of a sliding surface it is alternatively also possible to press the steps in such a way that the sealing edges do not run in parallel. The variation in the distance between the sealing edges on the upper side and the underside permits the elasticity of the sealing sliding surfaces to be set over the length of the sealing edges. This is particularly advantageous in application cases such as, for example, a cylinder head gasket in which different pressure distributions are present over the length of the sealing edges and owing to the different temperature conditions on the one hand when the engine is cold and on the other hand when the engine is hot the same elasticity does not always represent the optimum value over the length of the sealing edges but rather different elasticities are required depending on the position.

Furthermore it is advantageous to stamp in the steps for setting the elasticity either plane-parallel with respect to one another or obliquely. This embodiment does not necessarily require steps on the upper side and underside of a sliding surface but rather it is also possible when a step is stamped in only on one side of a sliding surface.

The supporting region of a sliding surface can be arranged on the inside or the outside of the sliding surface. Depending on the requirement, the one or the other embodiment is advantageous. For example, in the case of cylinder head gaskets it is advantageous to select the support on the outside on both sides between the combustion chambers while in the case of engines with collar sleeves it is advantageous to select the support in such a way that the support rests on the housing behind the collar, and the sliding surface is only pressed onto the collar elastically.

A further possibility is to provide the supporting regions on both sides of the sliding surface and to configure the supporting regions with a different material thickness. The seal which is clamped in between the cylinder head and cylinder block in the installed state gives rise to partially different degrees of deformation of the components and as a result locally also to greater or lesser degrees of conicity.

Given a load-bearing sliding surface width of 5-6 mm, the pressure distribution on the cross section of the sliding surfaces can be distributed in a selective fashion by virtue of the fact that the external support and the internal support, i.e., the supporting regions of a sliding surface, are embodied with different thicknesses.

In particular when the seal or the sealing layer is used as a cylinder head gasket it is advantageous if the sliding surfaces are joined between the combustion chamber openings and then branch again.

According to a further advantageous embodiment it is favorable if the non-supporting regions of a sliding surface have recesses on one side or on both sides. This permits selective setting of the elastic-plastic deformation curve by changing the section modulus of the bending cross section.

The seal or sealing layer is advantageously used as a cylinder head gasket or flange seal. Both types of seal constitute mass products so that the advantage of extremely favorable and fast production, in particular, production through a single stamping step, provides an immense cost saving.

Embodiments of the invention also include a method for producing a seal or sealing layer as described above which is characterized in that a sheet-metal layer with a constant material thickness is inserted into a stamping tool, and the sliding surface of the seal or the sealing layer is produced by stamping, wherein the stamping tool has an upper part and a lower part, and during the stamping process the space between the upper part and the lower part in the region of a sliding surface is filled in completely when there is a maximum stamping force.

The sliding surface is preferably produced in a single stamping process.

The sliding surfaces are advantageously produced here by a combination of transverse stamping and perpendicular expulsion stamping.

For this purpose, projections or claw fasteners are advantageously formed both on the upper part and on the lower part of the stamping tool, on both sides of a sliding surface which is to be formed.

The combination of the transverse stamping with the customary perpendicular expulsion stamping causes the claw fasteners on both sides to act as a termination so that a very high pressure is produced in the interior of the stamping mold in the region between the claw fasteners, which high pressure presses the stamping material against the surfaces of the mold and therefore automatically produces calibration at the end of the combined stamping process.

This combined stamping method with calibration without additional support next to the seal or sealing layer which is actually to be stamped carries out the following three functions in a single stroke:
1. partitioning off of the sliding surfaces to be stamped on both sides by the claw fasteners,
2. expulsion of material between the claw fasteners, that is to say toward the inside in the partitioned off region and therefore thickening of the material, and
3. calibration of the filled-in mold region.

All three functions can be carried out in just a single stroke, wherein it is also the case that only a single stamping force is necessary for this due to minimum friction.

Since no additional support is necessary between the upper part and the lower part of the stamping tool, no excess pressing force is required for the support. It is also the case that no thickness errors due to undesired local deformation of the support can creep in since no support is required. A further advantage of the method is also the fact that the sliding surfaces can be applied even when there are complicated geometries of a cylinder head gasket since no space is required for additional support and therefore any desired geometries of the sliding surfaces are possible. The entire load, that is to say the full pressing force, only occurs at the end of the stamping process for large stamping surfaces so that no large friction occurs during the expulsion process and the entire deformation can be carried out with a small stamping force.

In the case of the blank for the seal or sealing layer it is already possible to punch out the openings for the combustion chambers, fluid lines and screws before the stamping step. However, it is also possible to punch out these openings in a second punching step or in combination with the stamping step.

Further advantages are disclosed in the following description of the figures.

### BRIEF DESCRIPTION OF THE DRAWINGS

The invention will be explained in more detail below on the basis of exemplary embodiments illustrated in the figures, in which:

FIG. 1 shows a cylinder head gasket in a view from above,

FIG. 2 shows a flange seal in a view from above,

FIG. 3 shows the section A-A from FIG. 1 in a 20-times enlargement,

FIG. 4 shows the section B-B from FIG. 1 in a 20-times enlargement,

FIG. 5 shows the section C1-C1 from FIG. 1 in a 20-times enlargement,

FIG. 6 shows the section C2-C2 from FIG. 1 in a 20-times enlargement,

FIG. 7A shows a detail of a collar sleeve motor in the region of the seal between the cylinder head and engine block in a schematic cross section,

FIG. 7B shows the seal used in FIG. 7A before the installation,

FIG. 7C shows an alternative embodiment to the seal illustrated in FIG. 7B,

FIG. 8A shows a stamping tool in cross section,

FIG. 8B shows a seal or sealing layer which is shaped with a stamping tool according to FIG. 8A,

FIG. 9A shows a further stamping tool in cross section,

FIG. 9B shows a seal or sealing layer which is shaped with the stamping tool according to FIG. 9A, and

FIG. 10 shows a cross section of a stamping tool for producing a sliding surface with a recess on the underside.

The following list of reference numerals can be used in conjunction with the drawings.
1 Combustion chamber openings
2 Screw openings
3 Openings for fluid lines
4 Sealing region
5 Supporting region
6 Opening
7 Undeformed cross section of the piece of sealing sheet metal
8 Connecting web
9 Sliding surfaces
10 Step
11 Sealing edge
12 Slope
13 Recesses
14 Engine block
15 Collar sleeve
16 Sleeve collar
17 Cylinder head
18 Upper part of the stamping tool
19 Lower part of the stamping tool
20 Projections on the upper part and lower part of the stamping tool, claw fasteners
21 Cavity
22 Slope
23 Horizontal section
24 External slope
25 Vertical region
26 Step
27 Projection for recess
28 Opening

### DETAILED DESCRIPTION

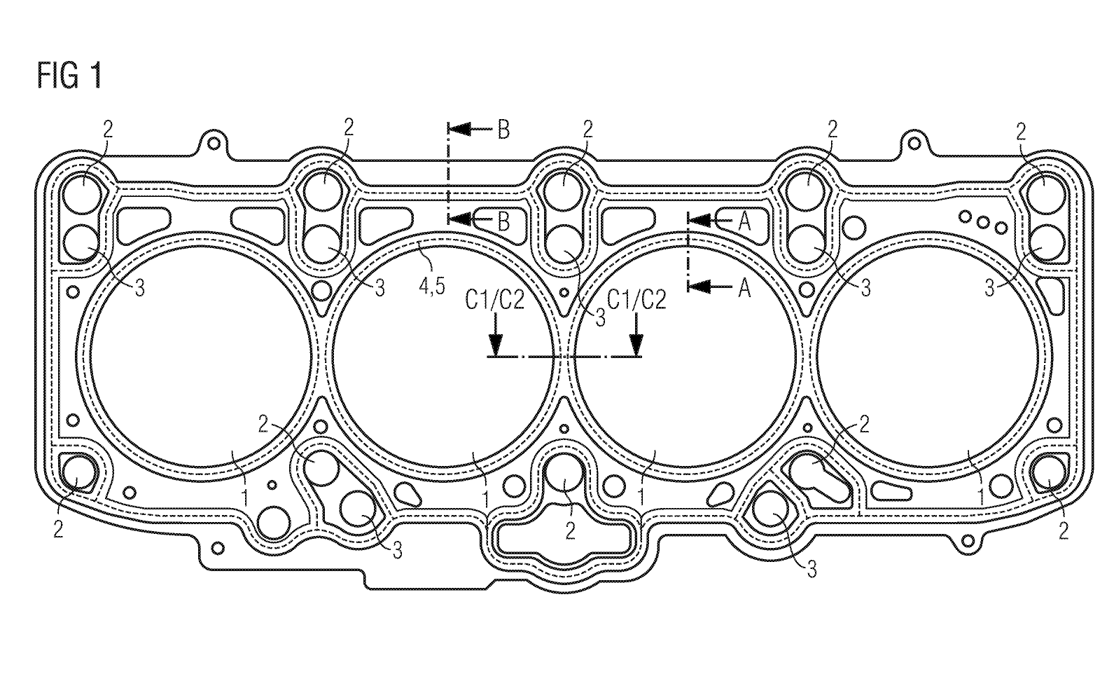

FIG. 1 shows in the view from above a cylinder head gasket for a four-cylinder engine. The cylinder head gasket can be embodied in the illustrated exemplary embodiment as a single-layer seal made of metal or as a sealing layer of a multi-layer seal made of metal. The cylinder head gasket has four combustion chamber openings 1, a plurality of screw openings 2 and openings 3 for the fluid lines, that is to say the connecting lines for water and oil.

In particular the combustion chamber openings 1 have to be surrounded by a sealing region 4 and a supporting region 5, wherein the supporting region 5 serves to maintain the elasticity of the sealing region 4. In FIG. 1, the supporting region 5 and the sealing region 4 are shown as dashed lines.

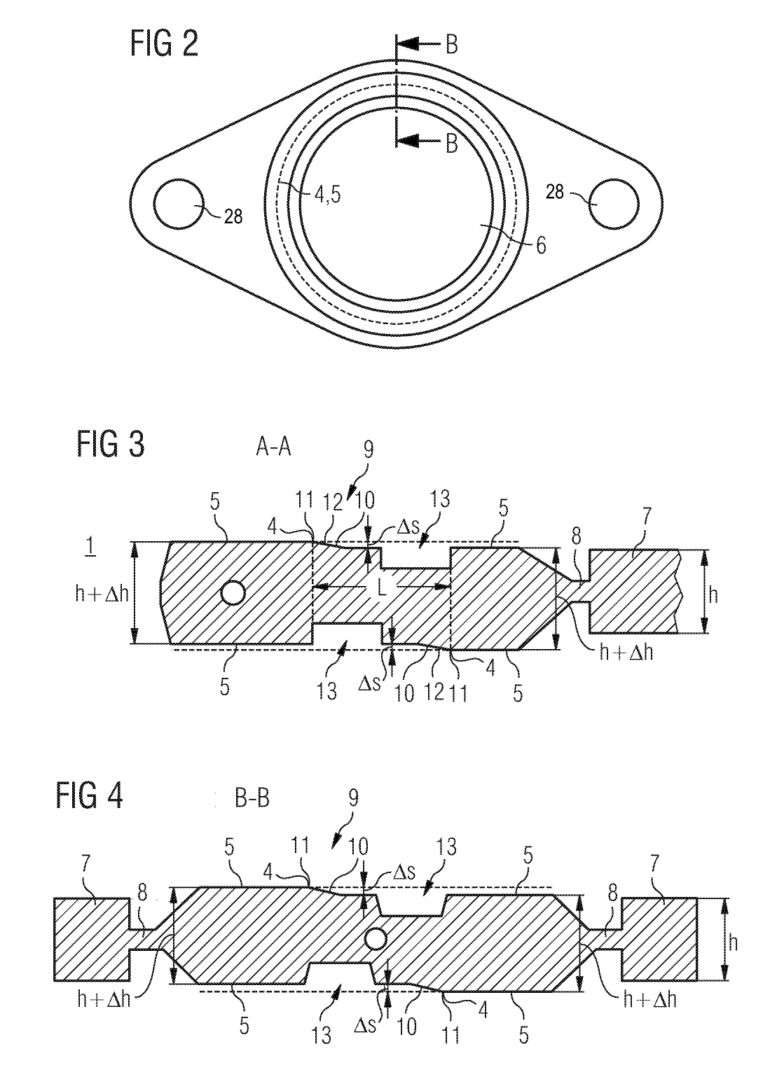

FIG. 2 shows a different embodiment of the seal or sealing layer, this time as a flange seal. The flange seal has in the center an opening 6 for the transportation of fluid or gases, which opening 6 is also surrounded by a supporting region 5 and sealing region 4. The latter is once again illustrated schematically by dashes.

In addition, the flange seal has on both sides openings 28 which serve only for securement by means of screws.

FIG. 3 shows the section A-A from FIG. 1 in a 20-times enlargement.

The right-hand side of the section A-A shows the seal or sealing layer in the unshaped cross section 7. In the unshaped state, the sheet-metal layer has a height h. A thickened sliding surface 9 is connected to the unshaped piece of sealing sheet metal 7 via a relatively narrow connecting web 8. The thickened sliding surface 9 is produced by stamping and thickened to the cross section h+Δh from the original cross section h. The sliding surface 9 has supporting regions 5, in particular those regions which are thickened to the material thickness h+Δh and sealing regions 4.

Those regions of the thickened sliding surface 9 which are elastically prestressed in the installed state of the sliding surface and in a defined region bring about a sealing effect due to the formation are referred to as sealing regions 4. For a person skilled in the art it is self-evident that a sealing effect is also achieved in each of the supporting regions 5. In the illustrated exemplary embodiment, a person skilled in the art recognizes that after the installation the thickened sliding surface 9 is elastically deformed in such a way that in FIG. 3 the right-hand supporting region 5 is also elastically prestressed on the underside, in particular in the left-hand region, and therefore contributes to the sealing effect. These sealing regions which are arranged in the region of the supporting regions 5 are not provided with the reference symbol 4 in the following exemplary embodiments and figures.

Steps 10, which form a vertical offset of Δs compared to the thickened height h+Δh in the respective surface are stamped in both on the upper side and on the underside of the sliding surface 9. Defined sealing edges 11 are provided on the sealing regions 4 by means of the steps 10. The steps 10 are not vertical in the junction with the supporting region 5 but rather formed by means of a slope 12 which is adapted in angle to a coating which is to be applied later to the seal or sealing layer.

Furthermore, recesses 13 which give a higher degree of elasticity to the sliding surface 9 are provided on both sides of the sliding surface 9. The recesses 13 are arranged in such a way that they are arranged between the steps 10 and are advantageously aligned with the steps 10 on the outer side.

The steps are arranged spaced apart from one another by the measure L. The greater the selection of measure L, the softer and more elastic the sliding surface 9 becomes. The recesses 13 make the sliding surface additionally softer and more elastic. The measure L or the arrangement of the recesses can vary over the length of the sealing edges 11 or of the sealing regions 4 depending on which elasticity is required.

In FIG. 3, the section A-A is illustrated in the undeformed state of the seal or sealing layer. In the installed state, the sliding surface 9 deforms elastically so that the sealing regions 4 bear elastically prestressed against the steps 10. The deformation is taken up by the connecting web 8, which therefore acts as a hinge point between the sliding surface 9 and the undeformed piece of sealing sheet metal 7.

FIG. 4 shows the section B-B from FIG. 1.

FIG. 4 shows essentially the same formation of the sliding surface 9 as in FIG. 3, wherein the sliding surface 9 in the detail according to FIG. 4 is connected on both sides to the undeformed piece of sealing sheet metal 7 via connecting webs 8.

FIG. 5 shows the cross section C1-C1 from FIG. 1, also in a 20-times enlargement. The cross section from FIG. 5 shows the region between two combustion chamber openings 1. The formation of the sealing sliding surface 9 is configured essentially identically to that described in FIG. 3 and in FIG. 4. All that is missing on both sides is the connection via a connecting web 8 to the undeformed piece of sheet metal 7. This shows that in the region between the combustion chamber openings the sliding surfaces run together, i.e. are joined and then branch again.

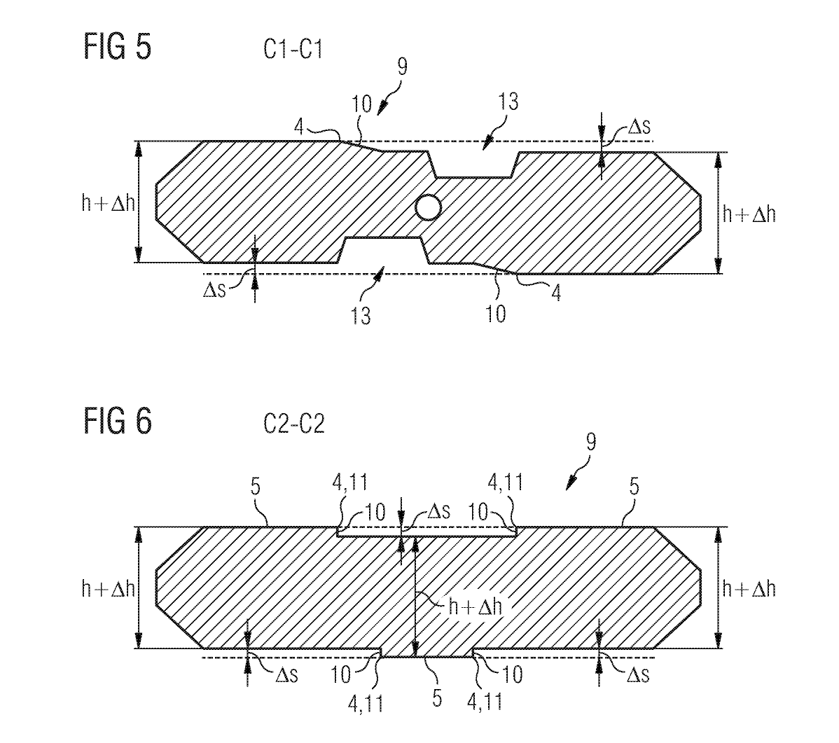

FIG. 6 shows an alternative embodiment of the seal or sealing layer in the region between the combustion chamber openings 1. In FIG. 6, the section C2-C2 is also illustrated in a 20-times enlargement. The sealing sliding surface 9 is thickened in this region to the thickness h+Δh by stamping. An outwardly pointing step 10 with the height different Δs is stamped in on both sides of the underside. Two steps 10 with a vertical offset of Δs are also stamped in on the upper side. The steps on the upper side point inward so that a recess is produced between them. In order to bring about elastic bending, the steps 10 on the underside are arranged inside the steps 10 on the upper side, i.e., in the region of the recess. The region between the steps 10 on the underside and the regions outside the steps 10 on the upper side function as supporting regions 5. The material thickness of the sliding surface is always h+Δh.

If the sliding surface 9 is not arranged between two combustion chamber openings, the lower supporting region 5 branches so that sliding surfaces 9 are produced again as illustrated in FIGS. 3 to 5.

As a result of the stamped-in steps 10, sealing regions 4 or sealing edges 11 are formed. The steps 10 are stamped in at a right angle in this exemplary embodiment.

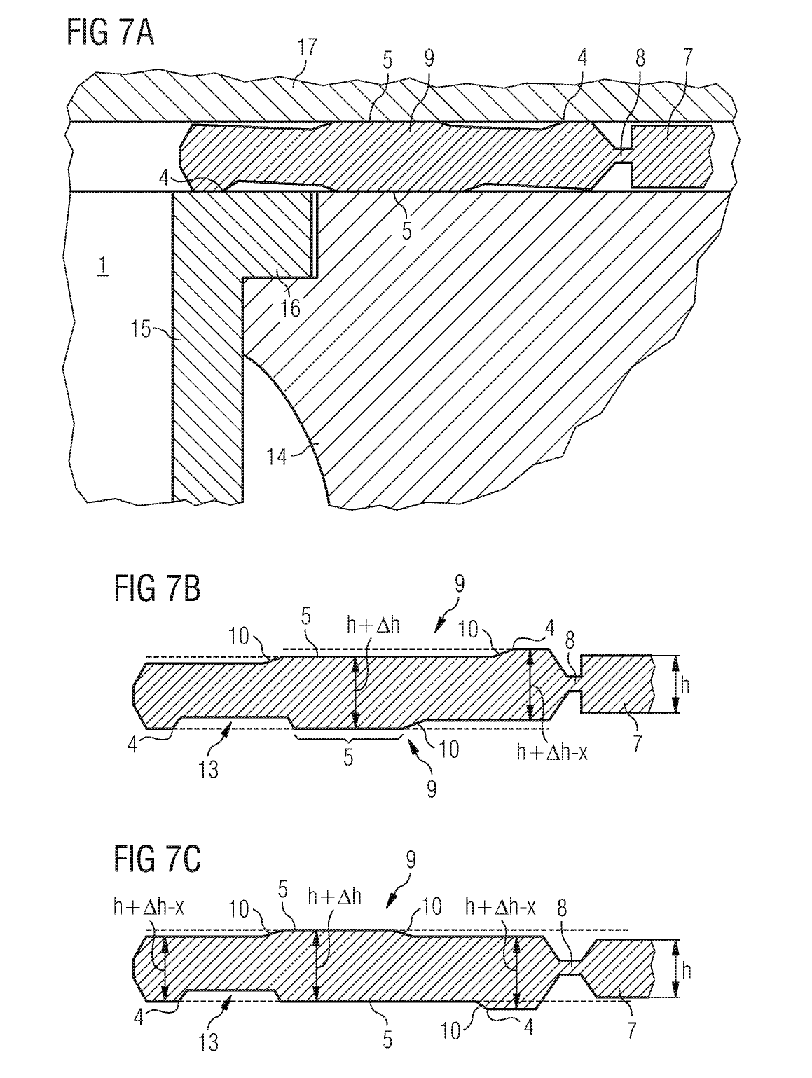

FIG. 7A shows the embodiment of the seal or sealing layer according to the invention when used in an engine with collar sleeves, and FIG. 7B shows only the seal before installation.

FIG. 7A is a schematic illustration of the engine block 14, the collar sleeve 15 with a corresponding sleeve collar 16, the associated cylinder head 17 and, arranged therebetween, a detail of a single-layer metal seal, of a collar sleeve motor. In the right-hand region, the undeformed region 7 of the sealing sheet metal can be seen, and this is in turn connected to the thickened sliding surface 9 via a connecting web 8.

The formation of the sliding surface 9 will be explained below with reference to FIG. 7B, which, like FIGS. 3 to 6, show the sliding surfaces 9 in the state before installation. Two steps 10 are stamped in on the upper side and one step 10 is stamped in on the underside.

A supporting region 5 is formed between the step 10 on the underside and the left-hand step 10 on the upper side of the sliding surface 9. In this region, the sliding surface 9 is thickened to the material thickness h+Δh.

Since the supporting region 5 on the underside of the seal is not intended to come to rest on the collar 16 of the collar sleeve 15, a recess 13 is provided on the underside next to the supporting region 5, and the step 10 which is directed in the direction of the combustion space is provided on the upper side underneath the recess 13 so that the left-hand region of the seal or sealing layer which is directed towards the combustion chamber 1 only rests in an elastically prestressed fashion on the collar 16 of the collar sleeve 15.

Since the underside of the free end rests at the same level as the thickened supporting region 5, the elastic prestressing is achieved by virtue of the fact that the surface of the collar sleeve 16 lies at a higher level than the underside of the supporting region 5.

To the right of the supporting region 5, the seal or sealing layer has a material thickness of h+Δh−x. As a result of the material thickness which is reduced by x, in the installed state the sliding surface 9 is also deformed elastically in the right-hand region, and a defined sealing region 4 is produced on the right-hand stamped-in steps 10.

To the left of the supporting region 5, the free end is made relatively thin on the upper side owing to the recess 13 and the further step 10. Since the surface of the sleeve collar 16 lies at a somewhat higher level than the surface of the motor block 14 on which the supporting region 5 bears, the free end presses elastically prestressed against the surface of the sleeve collar 16 and therefore forms a further sealing region 4.

FIG. 7C shows an alternative embodiment to FIG. 7B. The embodiment according to FIG. 7C also has a supporting region in the center, wherein a recess 13 is arranged to the right thereof on the underside, and a step 10 is arranged above the recess 13. The left-hand section of the sliding surface 9 is again made relatively thin, with a material thickness on the left-hand outer end of h+Δh−x.

The supporting region has a material thickness of h+Δh, and a step 10 is in turn stamped in on the upper side to the right of the supporting region 5, and the material is thickened to h+Δh−x on the underside, offset to the right with respect to the step 10 on the upper side.

The entire sliding surface 9 is subsequently connected to the undeformed piece of sealing sheet metal 7 with a material thickness of Δh via the hinge point 8.

During the installation, the supporting region 5 supports the seal between the engine block and cylinder head as illustrated in FIG. 7A.

The left-hand outer region is again pressed in an elastically prestressed fashion onto the surface of the collar sleeve 15. This is in turn the case since the surface of the collar sleeve 15 is generally arranged slightly above the surface of the surrounding engine block on which the supporting region 5 is supported.

Likewise, after installation the right-hand region of the sliding surface is elastically prestressed with the material thickness h+Δh−x so that a sealing region 4 is also produced here on the step 10 on the underside. The connecting web 8 absorbs the corresponding deformation. This design has the advantage that the sliding surface 9 is bent upward on both sides of the supporting region and force symmetry is therefore produced with respect to the supporting region 5, and a continuous torque acting on the supporting region 5 is therefore avoided.

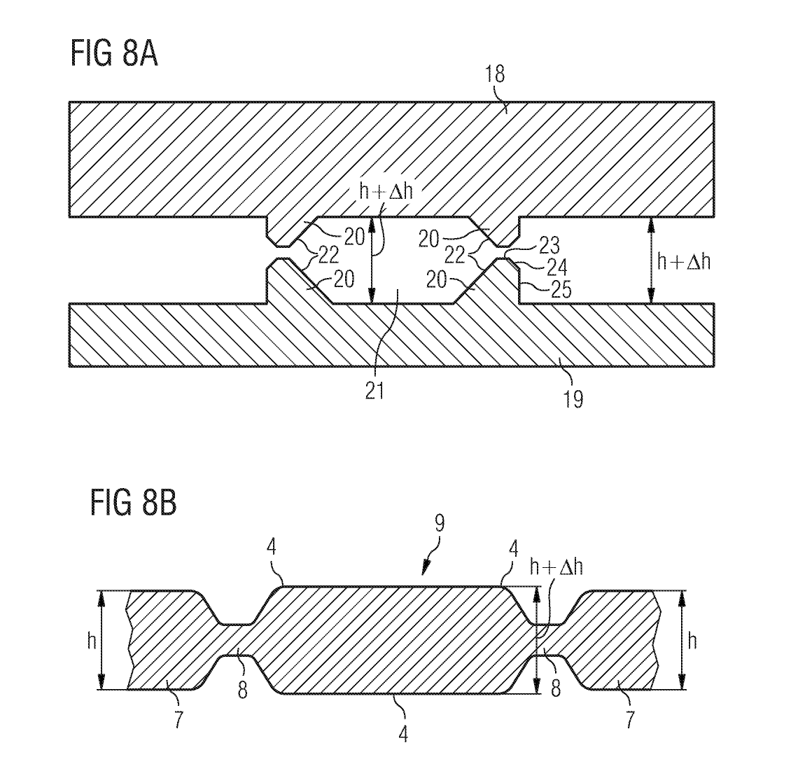

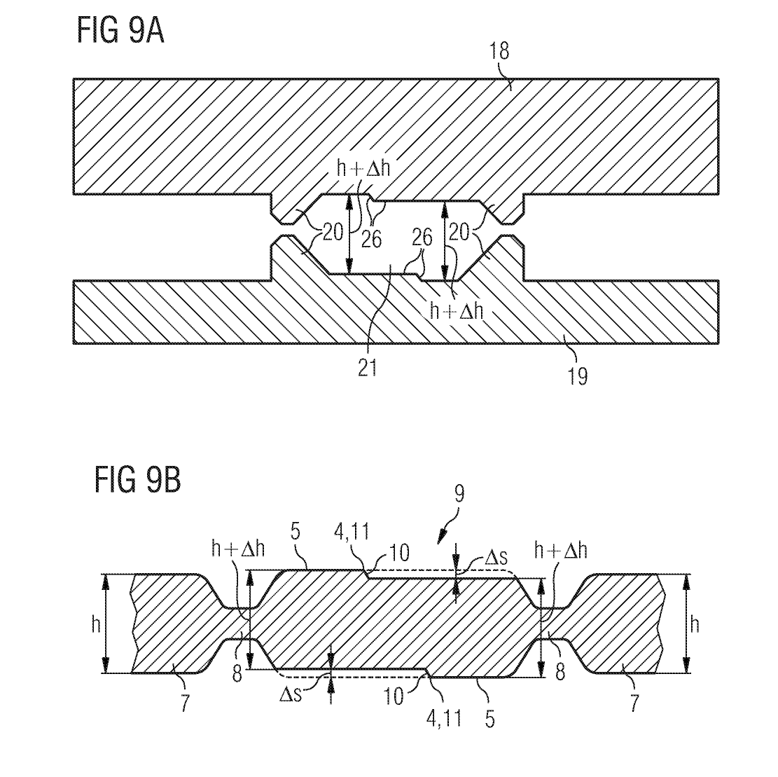

FIG. 8A is a schematic view of a stamping tool with an upper part 18 and a lower part 19 for the production of a seal or sealing layer according to the invention. Aligned projections 20, referred to as claw fasteners, which define a cavity 21 between them, are arranged on the underside of the upper part 18 and on the upper side of the lower part 19. The projections 20 are each provided on the inside with a slope 22 which during the stamping process laterally compresses the material and therefore thickens it. In order to form the connecting webs 8, the projections have at their ends a horizontal section 23, adjoining short external slopes 24 and, on the external slope 24, an adjoining vertical section 25. The distance between the underside of the upper part 18 and the upper side of the lower part 19 has the height h+Δh, that is to say the height of the original sheet metal thickness plus the thickened portion, both in the cavity 21 and to the side of the cavity 21 in the end position of the stamping process.

The geometry of the stamping tool ensures that as a result of the projections 20 and in particular as a result of the slopes 22 the material is laterally compressed in the region of the cavity 21 and is therefore thickened from the original sheet metal thickness h to a thickness h+Δh. The projections 20 penetrate the material with a relatively small stamping force since the penetration of the projections 20 into the material to be stamped only has to be overcome by the stamping force at the start of the stamping phase. Outside the projections 20, only short external slopes 24 and the adjoining vertical region 25 are provided since a thickened portion in this region is to be largely avoided. This is achieved by the vertical region 25 since lateral expulsion therefore does not take place in this region.

The short external slope 24 serves merely to achieve a stable connection of the connecting web 8 to the undeformed region 7 of the piece of sealing sheet metal.

FIG. 8B is a basic view of a seal or sealing layer which has been produced by a tool according to FIG. 8A. On both sides, the undeformed region of the piece of sealing sheet metal is located with a material thickness of h. The sliding surface 9 is thickened to the material thickness h+Δh by transverse stamping. In the stamping tool according to FIG. 8A, the slopes 22 are made longer on the lower part than the slopes 22 on the upper part, as a result of which an asymmetrical sliding surface geometry is produced and the sliding surface is slightly curved owing to the elastic springing back. As a result, a sealing region 4 is produced bottom center and two sealing regions 4 are produced at the top on both sides. In the illustrated exemplary embodiment, the original sheet metal thickness is 1.3 mm, while in the thickened region the sliding surface 9 has a material thickness of h+Δh=1.48 mm. The thickened portion Δh is therefore 0.18 mm.

FIG. 9A shows a similar stamping tool to that in FIG. 8A, wherein in each case a step 26 is formed in the cavity 21 both on the upper side and on the underside. FIG. 9 shows the resulting cross section of a seal in the region of the sliding surface 9 which has been produced by a tool according to FIG. 9A.

The sealing sliding surface 9 also has steps 10 on the upper side and underside as a result of the steps 26 in the stamping tool. If the step 10 has, for example, a height of Δs=0.08 mm, the thickening of the entire sliding surface occurs only to an overall material thickness of h+Δh=1.4 mm. As a result of the offset design of steps 10 on the upper side and underside, the clear width between the upper side and underside is 1.48 mm but, as explained with regard to FIGS. 3 to 5, the sliding surface 9 is deformed elastically and plastically by the stamped-in steps 10 and the supporting regions 5 are formed with a material thickness according to this example of 1.4 mm by the thickened regions h+Δh.

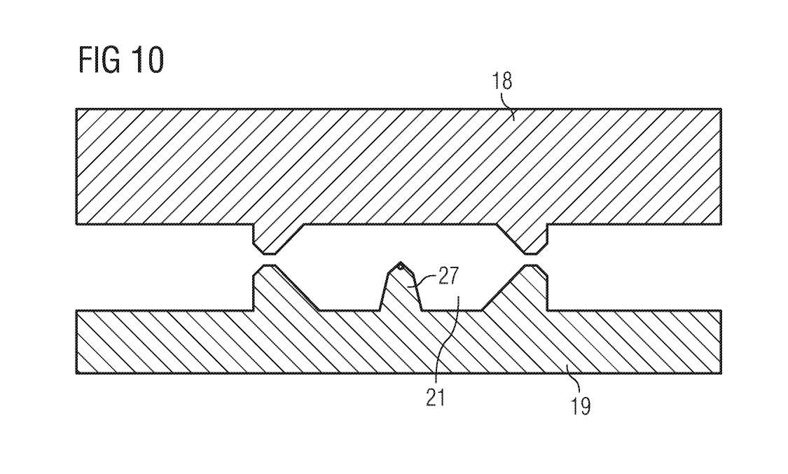

FIG. 10 shows a cross section of a further stamping tool which differs from the stamping tool illustrated in FIG. 8A in that a further projection 27 for forming a recess 13 on the underside of a sliding surface 9 is provided on the lower part.

The manufacture of the seal is extremely simple and therefore cost-effective. A sheet metal layer with a constant material thickness is inserted into the stamping tool and in a stamping step the sealing layer or seal is produced with the desired sliding surfaces 9 and geometries. The seal can then merely be additionally provided with a wear-resistant coating.

All of the geometries of the sealing sliding surfaces, even if not illustrated in the figures, for example with obliquely stamped-in steps or just one step on the upper side or one step on the underside or a plurality of recesses, are produced in one stamping step. Each sliding surface is thickened by transverse stamping and the desired geometry of the sliding surface is achieved by virtue of the formation of the upper part and lower part of the stamping tool. The cavity in which the sliding surface 9 is formed between the upper part and the lower part of the stamping tool is completely filled in the stamping process, as a result of which calibration is simultaneously also produced and therefore sliding surfaces 9 are always produced with the desired geometry and thickness. Additional support for the production of the seal or sealing layer according to the invention is not necessary and also not desired because by virtue of an additional support only relatively large stamping forces would be necessary and additional space would be taken up.

The invention is not restricted to the illustrated exemplary embodiments but instead, in particular, embodiments without stamped-in steps or with in each case just one step on the upper side and on the underside, respectively, are also possible.

What is claimed is:

1. A single-layer seal or a sealing layer of a multi-layer seal made of metal, the single-layer seal or sealing layer comprising:
supporting regions; and
sealing regions;
wherein at least one supporting region and at least one sealing region are embodied by a stamped sliding surface with a thickness that is greater than an original sheet-metal thickness, wherein a step is stamped onto the upper side and/or the underside of the at least one sliding surface such that the sliding surface bends elastically in an installed state, and wherein the sealing region is prestressed elastically.

2. The single-layer seal or sealing layer according to claim 1, wherein the at least one sliding surface has, through transverse stamping, a greater material thickness than the original sheet-metal thickness.

3. The single-layer seal or sealing layer according to claim 1, wherein the at least one sliding surface is produced by a single stamping process.

4. The single-layer seal or sealing layer according to claim 1, wherein a sealing edge is formed by the stamped-in step.

5. The single-layer seal or sealing layer according to claim 1, wherein a junction between the at least one sliding surface and an original surface of the seal is formed by at least one relatively thin hinge point or a connecting web.

6. The single-layer seal or sealing layer according to claim 4, wherein the sealing edge has a deformation that is embodied as a function of a coating that is applied to the sliding surface.

7. The single-layer seal or sealing layer according to claim 1, wherein the step is formed on the upper side and a second step is formed on the underside of the sliding surface, the step and second step being stamped in in such a way that sealing edges run in parallel.

8. The single-layer seal or sealing layer according to claim 1, wherein the step is formed on the upper side and a second step is formed on the underside of a sliding surface, the step and the second step being stamped in in such a way that sealing edges do not run in parallel.

9. The single-layer seal or sealing layer according to claim 1, wherein the step is formed on the upper side and a second step is formed on the underside of a sliding surface, the step and the second step being stamped in in a plane-parallel or oblique fashion.

10. The single-layer seal or sealing layer according to claim 1, wherein the at least one supporting region of a sliding surface is arranged on the inside or the outside of the sliding surface.

11. The single-layer seal or sealing layer according to claim 1, wherein the at least one supporting region comprises supporting regions with different material thicknesses that are provided on both sides of each sliding surface.

12. The single-layer seal or sealing layer according to claim 1, wherein, non-supporting regions of a sliding surface have recesses on one side or on both sides.

13. The single-layer seal or sealing layer according to claim 1, wherein a plurality of sliding surfaces are formed per seal or sealing layer, wherein the sliding surfaces join and branch.

14. The single-layer seal or sealing layer according to claim 1, wherein the seal comprises an at least single-layer cylinder head gasket or flange seal.

15. The single-layer seal or sealing layer according to claim 1, wherein the entire seal or sealing layer is produced in a stamping step.

16. The single-layer seal or sealing layer according to claim 1, wherein the entire seal or sealing layer is produced with additional stamping steps for additional functions.

17. A method for producing a seal or sealing layer, the method comprising:
inserting a sheet-metal layer with a constant material thickness into a stamping tool; and
forming supporting regions and sealing regions from the sheet-metal layer, wherein at least one supporting region and at least one sealing region are embodied by a stamped sliding surface with a thickness that is greater than the constant material thickness, wherein a step is stamped onto the upper side and/or the underside of the at least one sliding surface such that the sliding surface bends elastically in an installed state, and wherein the sealing region is prestressed elastically.

18. The method according to claim 17, wherein the sliding surface of the seal or the sealing layer is produced by a stamping process, wherein the stamping tool has an upper part and a lower part, and during the stamping process the space between the upper part and the lower part in the region of a sliding surface is filled in completely when there is a maximum stamping force.

19. The method according to claim 17, wherein the sliding surface is produced by a single stamping process.

20. The method according to claim 17, wherein the sliding surface is produced by a combination of transverse stamping and perpendicular expulsion stamping.

21. The method according to claim 18, wherein the upper part and the lower part of the stamping tool have projections or claw fasteners on both sides of a sliding surface which is to be formed.

22. The method according to claim 18, further comprising applying a coating after the stamping process.
